(19) United States
(12) Patent Application Publication
(10) Pub. No.: US 2006/0211389 A1
(43) Pub. Date: Sep. 21, 2006

(54) Method and apparatus for narrowband platform interference mitigation

(75) Inventors: Wei Lin, San Jose, CA (US); Gordon Chinn, San Jose, CA (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/086,185

(22) Filed: Mar. 21, 2005

(51) Int. Cl. H04B 1/69

(52) U.S. Cl. 455/138; 455/241.1

(57) ABSTRACT

A method and apparatus for a platform interference mitigator are described herein.

### TECHNICAL FIELD

Embodiments of the invention relate generally to the field of wireless networks, and more particularly to mitigating for interference in computing platforms used in such networks.

### BACKGROUND

Convergence of communication, computing, high demand for mobility, and the vision of anywhere anytime connectivity are driving the high growth of adoption of wireless technologies into computing platforms. Wireless communication standards typically specify wireless receiver requirements on various types of communication link impairments. However, not all impairments may be adequately addressed by the requirements or otherwise in prior art wireless computing platforms.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a wireless network having a base station communicating with a computing platform over a wireless medium in accordance with an embodiment of the present invention;

FIG. 2 illustrates an embedded receiver of the computing platform in further detail in accordance with an embodiment of the present invention;

FIG. 3 illustrates a procedure for compensating for narrowband platform interference in accordance with an embodiment of the present invention; and

FIG. 4 illustrates a platform interference mitigator in accordance with an embodiment of the present invention.

### DETAILED DESCRIPTION

Illustrative embodiments of the present invention include a computing platform having a functional block to mitigate for narrowband platform interference.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific materials and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding embodiments of the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

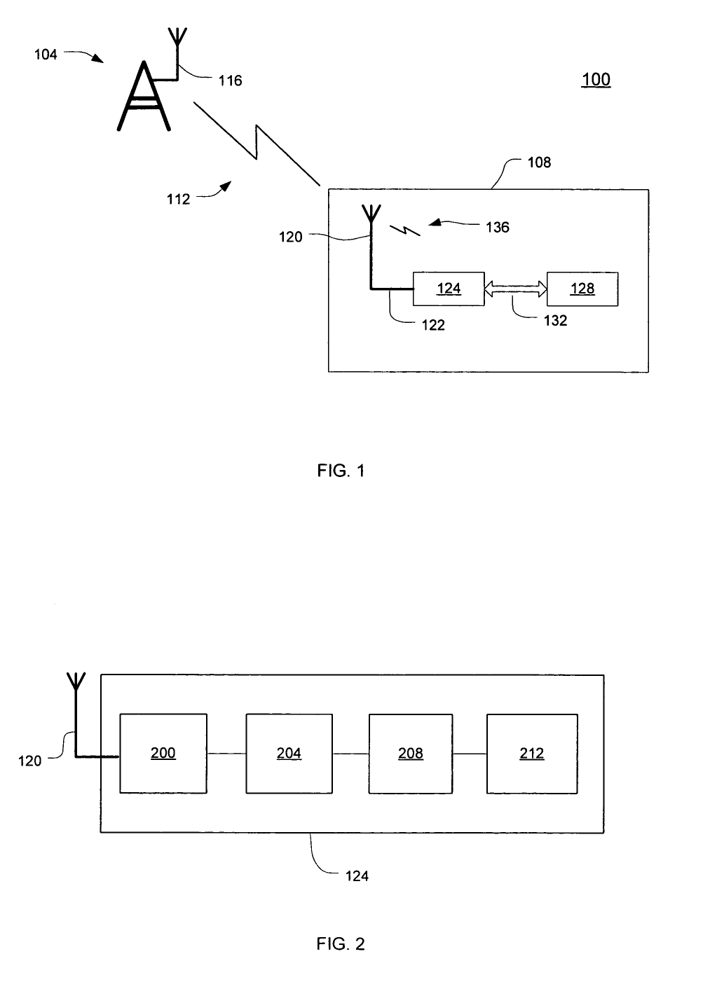

FIG. 1 illustrates a wireless network 100 having an access point, e.g., a base station 104 communicating with a computing platform 108 over a wireless medium 112 in accordance with an embodiment of the present invention. The base station 104 may have an antenna 116 to facilitate transmission of data to the computing platform 108 over the wireless medium 112. Likewise, the computing platform 108 may have an antenna 120, which may be embedded, to facilitate reception of data transmissions from the base station 104 over the wireless medium 112. In one embodiment the wireless medium 112 may be a channel in the radio-frequency (RF) spectrum.

The antenna 120 may receive a RF signal over the wireless medium 112 and output the RF signal over an interconnect 112 (e.g., trace, wire, line, etc.). A receiver 124 may be coupled to the metal interconnect 112 to receive the RF signal. The receiver 124 may also be coupled to a processor 128, such as a central processing unit (CPU) of the computing platform 108, over a data exchange component 132, e.g., a bus. Data may be transmitted over the data exchange component 132 and between the receiver 124 and the processor 128. In various embodiments the processor 128 may also be part of a hub chipset adapted to arbitrate data accesses between a CPU and other components, including the receiver 124.

In various embodiments, the computing platform 108 may include a transceiver having a transmitter and the receiver 124 to handle both incoming and outgoing wireless data transmissions.

In one embodiment, the antenna 120 may receive not only an incoming data transmission from the base station 104 but also narrowband interference 136 that may be sourced from the computing platform 108 itself. The narrowband interference 136 may have frequencies in the same band as the incoming data transmission. The resulting signal may be sent to the receiver 124. In accordance with embodiments of the present invention, the receiver 124 may develop a platform interference profile, which it may then use to compensate for at least some of the narrowband interference 136 that may otherwise interfere with the transmitted data.

In various embodiments the computing platform 108 may be a wireless mobile computing device such as, but not limited to, a notebook computing device, a personal-digital assistant, or a cellular phone.

In various embodiments, the network 100 may have a wide variety of topologies, protocols, and/or architectures. In an embodiment the network 100 may comply with one or more standards for wireless communications, including, for example, one or more of the IEEE 802.11 (a), 802.11 (b) and/or 802.11 (g) (ANSI/IEEE 802.11 standard, IEEE std. 802.11-1999, reaffirmed Jun. 12, 2003) standards for wireless local area networks (WLANs), along with any updates, revisions, and/or amendments to such. In other embodiments, the network 100 may be a wireless wide area network (WWAN) or a wireless personal area network (WPAN). In various embodiments, the network 100 may additionally or alternatively comply with other communication standards.

FIG. 2 illustrates the receiver 124 in further detail in accordance with an embodiment of the present invention. In particular, the receiver 124 may have a signal converter 200 coupled to the antenna 120. The signal converter 200 may include a number of components adapted to cooperate with one another in order to receive an incoming RF signal and to output a digital baseband (DBB) signal, based at least in part on the incoming RF signal. In one embodiment, the signal converter 200 may include a bandpass filter to allow frequencies within a pass range through, while rejecting frequencies outside of the pass range. The signal converter 200 may also have a down converter coupled to the bandpass filter. The down converter may demodulate the band of frequencies output from the bandpass filter and output an analog baseband signal. In one embodiment, an analog-to-digital converter may receive the analog baseband signal and output the DBB signal.

The DBB signal output from the signal converter 200 may include portions contributed from a number of sources in addition to the incoming data transmission. For example, let the signal transmitted from the base station 104 be s(t), then the DBB signal output from the signal converter 200 may be represented by the following equation:
r(t)=s′(t)+N(t)+Q(t)+P(t); Eq. 1.

In this equation, s(t) may represent the received baseband signal, which may have been impacted by channel impairments such as, but not limited to, fading, multipath delay spread, and Doppler spread. N(t) may represent additive white Gaussian noise (AWGN), which may come from various sources. Q(t) may be quantization noise that may result from converting the analog baseband signal to the DBB signal. P(t) may represent narrowband interference 136 sourced by one or more components of the computing platform 108.

In one embodiment, the narrowband platform interference P(t) 136 may not be subject to significant fading, delay spread, or Doppler spread. The time-domain and/or frequency-domain characteristics of the narrowband platform interference P(t) 136 may be relatively stable over a period of time, and may be subject to infrequent abrupt changes due to, e.g., platform reconfigurations. This traits may facilitate the development and use of a platform interference profile to mitigate platform interference.

Narrowband platform interference 136 may be provided by harmonics of various platform clocking signals within the computing platform 108, for example.

In an embodiment, the DBB signal output by the signal converter 200 may be input to a platform interference mitigator 204. In one embodiment, the platform interference mitigator 204 may develop a narrowband platform interference estimation. This estimation may be used as a basis for mitigation by providing interference attributes for use in generation of an estimated interference signal constructed by the platform interference mitigator 204. In one embodiment, the platform interference mitigator 204 may output an adjusted DBB signal based at least in part on a comparison between the DBB signal and the interference signal. In one embodiment, the adjusted DBB signal may be developed by subtracting the estimated interference signal from the DBB signal.

In one embodiment, a narrowband platform interference estimation may be developed based at least in part upon a narrowband platform interference profile. The narrowband platform interference profile may include estimated attributes of the narrowband platform interference such as, but not limited to, frequency, amplitude, and phase. These attributes may be estimated and/or utilized over the same or different periods.

In one embodiment, the adjusted DBB signal may be transmitted to a DBB processing block 208. The DBB processing block 208 may receive the adjusted DBB signal and output an estimated copy of the data that was transmitted in the incoming data transmission sent by the base station 104 over the network 100. The data output from the DBB processing block 208 may be in a format to facilitate subsequent processing by upper layers 212. In one embodiment, the upper layers may provide various control and/or management functions of the receiver 124.

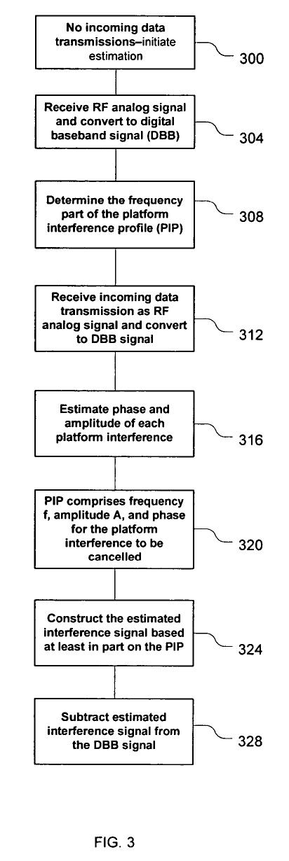

FIG. 3 illustrates a procedure for compensating for narrowband platform interference in accordance with an embodiment of the present invention. In one embodiment, an absence of incoming data transmissions may initiate a narrowband platform interference estimation procedure 300. In various embodiments, the absence of an incoming data transmission may be detected and/or predicted in light of various network events and/or reference to the network's particular protocols. For example, in an embodiment where the network 100 complies with an 802.11 WLAN standard, the absence of an incoming data transmission may be predicted during a back-off period of a distributed coordination function (DCF) interframe spacing (DIFS).

An antenna may receive an RF analog signal over a first time period, e.g., during a quiet period, and transmit it to a signal converter to be converted to a DBB signal 304. Because of the absence of an incoming data transmission, a substantial portion of the received RF analog signal may be from platform interference. In one embodiment, an estimation of the frequency of the narrowband platform interference profile may be determined by analysis of the DBB signal 308. The DBB signal may include a number of spikes. These spikes may be identified and their frequency may be determined through real-time analysis. For example, the frequency of the spikes may be determined using a Fast Fourier Transform (FFT). Additionally, various embodiments may use other frequency estimation techniques.

In one embodiment an incoming data transmission may be a constituent part of a second RF signal received by the antenna over a second time period. This second RF signal may be converted to a second DBB signal in a manner similar to that discussed above 312. An estimation of the phase and amplitude of each narrowband platform interference may be obtained by analyzing the second DBB signal and may be used to augment the narrowband platform interference profile 316.

Using one or more of the above estimations may result in a narrowband platform interference profile having at least one attribute such as, but not limited to, frequency (f), amplitude (A), and phase (φ) 320. An estimated interference signal may then be generated based at least in part on the platform interference profile 324. The estimated interference signal may be used to remove at least a portion of the overall narrowband platform interference that is commingled with the incoming data transmission 328.

Components described and discussed with reference to the procedure depicted in FIG. 3 may be similar to like-named components in other embodiments discussed herein.

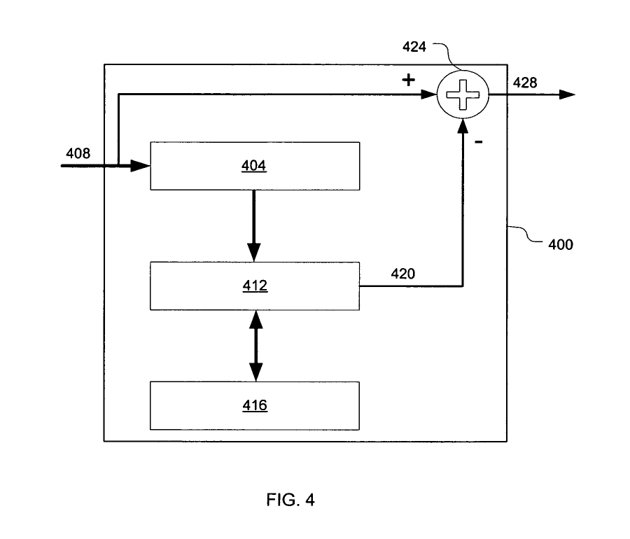

FIG. 4 illustrates a narrowband platform interference mitigator 400 in accordance with an embodiment of the present invention. The platform interference mitigator 400 may be similar to, and substantially interchangeable with, the platform interference mitigator 204 and will therefore be discussed with reference to similar components. In this embodiment the narrowband platform interference mitigator 400 may include a platform interference profile estimator (PIPE) 404. The PIPE 404 may receive a DBB signal 408 from the signal converter 200. In one embodiment, the DBB signal 408 may have a first portion provided by an incoming data transmission and a second portion provided by platform interference. The PIPE 404 may estimate a platform interference profile based at least in part on the DBB signal 408. This estimation may be done in a manner similar to that discussed above. In one embodiment, certain attributes of the platform interference profile may be estimated prior to reception of the DBB signal 408 with its associated incoming data transmission. For example, the frequency of the platform interference profile may be estimated prior to the reception of the DBB signal 408 based at least in part on an earlier DBB signal generated at a time period when an incoming data transmission is not expected. In this embodiment, the phase and amplitude of the platform interference profile may then be estimated during reception of the DBB signal 408.

The PIPE 404 may provide the platform interference profile to an interference signal constructor 412 in accordance with an embodiment of the present invention. The interference signal constructor 412 may cooperate with a sinusoidal generator 416 in order to effectuate the output of an estimated interference signal 420 based at least in part on the platform interference profile. In accordance with one embodiment, the interference signal 420 may then be fed to a comparator 424. The comparator 424 may also be coupled to receive the DBB signal 408. The comparator 424 may compare the DBB signal 408 to the interference signal 420, e.g., subtract the interference signal 420 from the DBB signal 408, and output an adjusted DBB signal 428 based at least in part on said comparison. The adjusted DBB signal 428 may be transmitted to the DBB processing block 208.

In one embodiment the comparator 424 may be an adder and the estimated interference signal 420 may be sign reversed prior to being transmitted to the comparator 424.

In one embodiment, a platform interference profile may include attributes for each one of a number of different interferences, e.g., a number of different narrowband interferences. In this embodiment, the interference signal constructor 412 may compute each estimated interference signal and add them together to develop the estimated interference signal 420. In this embodiment, if the platform interference profile is {(fᵢ, Aᵢ, φᵢ)}, where i=1, 2, . . . , N, then the estimated interference signal 420 may be represented by the following equation:

$${R}_{i} ( n ) = {\sum }_{i = 1}^{N} {A}_{i} Cos ( 2 π {f}_{i} {nT}_{s} + {ϕ}_{i} ) ; . \qquad Eq . 2$$

Where Tₛ is the time separation between adjacent digital samples. The estimated interference signal 420 Rᵢ(n) may then be subtracted from the DBB signal 408 in a similar manner as above.

Accordingly, methods and apparatuses for a narrowband platform interference mitigator have been described. Although the present invention has been described in terms of the above illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. A receiver of a computing platform comprising:
a signal converter to receive a radio-frequency signal having at least a portion representative of platform interference introduced by a host platform, and to generate a baseband signal based, at least in part, on the radio-frequency signal; and
a platform interference estimator, responsive to the signal converter, to receive the first baseband signal and to estimate the platform interference based, at least in part, on the baseband signal.

2. The receiver of claim 1, wherein the platform interference estimator is to generate a platform interference profile having at least one attribute selected from the group consisting of a frequency, an amplitude, and a phase based at least in part on the baseband signal.

3. The receiver of claim 2, wherein the platform interference profile includes a frequency based at least in part on the baseband signal; the signal converter is to receive the radio-frequency signal over a first time period and to receive another radio-frequency signal over a second time period, and to output another baseband signal based at least in part on the another radio-frequency signal; and the platform interference estimator is to receive the another baseband signal and to augment the platform interference profile with at least one of an amplitude or a phase based at least in part on the another baseband signal.

4. The receiver of claim 3, wherein the first time period is to occur when an incoming data transmission is not expected.

5. The receiver of claim 2, further comprising:
an interference signal constructor
to receive the platform interference profile from the platform interference estimator, and
to construct an interference signal based at least in part on the platform interference profile.

6. The receiver of claim 5, further comprising:
a sinusoidal generator to cooperate with the signal interference constructor to construct the interference signal.

7. The receiver of claim 5, wherein the signal converter is to receive another radio-frequency signal having an incoming data transmission over a second time period, and to output another baseband signal based at least in part on the another radio-frequency signal; and the computing platform further comprising:
a comparator
to receive the another baseband signal from the signal converter;
to receive the interference signal from the interference signal constructor; and
to output an adjusted baseband signal based at least in part on the received another baseband signal and the received interference signal.

8. The receiver of claim 7, further comprising:
a baseband signal processing block
to receive the adjusted baseband signal from the comparator, and
to output data transmitted in the incoming data transmission.

9. The receiver of claim 1, wherein the platform interference comprises narrowband platform interference.

10. A signal processing method in a computing platform, comprising:
receiving, at the computing platform, a radio-frequency signal having at least a portion representative of platform interference introduced by the computing platform;
converting, at the computing platform, the radio-frequency signal to a baseband signal; and
estimating, at the computing platform, the platform interference based at least in part on the baseband signal.

11. The method of claim 10, wherein said receiving of the radio-frequency signal occurs over a first period when an incoming data transmission is not expected.

12. The method of claim 11, wherein said estimating of the platform interference comprises:
obtaining, by the computing platform, a platform interference profile having at least one attribute selected from the group consisting of a frequency, an amplitude, and a phase based at least in part on the baseband signal.

13. The method of claim 12, wherein the platform interference profile includes a frequency based at least in part on the baseband signal, the method further comprising:
receiving, over a second time period, at the computing platform, another radio-frequency signal having an incoming data transmission;
outputting, at the computing platform, another baseband signal based at least in part on the another radio-frequency signal; and
augmenting, by the computing platform, the platform interference profile with at least one of an amplitude or a phase based at least in part on the another baseband signal.

14. The method of claim 13, further comprising:
generating, by the computing platform, an interference signal based at least in part on the frequency, phase, and amplitude of the platform interference.

15. The method of claim 14, further comprising:
subtracting, by the computing platform, the interference signal from the another baseband signal; and
outputting, at the computing platform, an adjusted baseband signal based at least in part on said subtracting of the interference signal from the another baseband signal.

16. The method of claim 12, wherein the platform interference profile includes a frequency based at least in part on the baseband signal, the method further comprising:
identifying, by the computing platform, a plurality of spikes in the baseband signal; and
determining, by the computing platform, the frequency based at least in part on the identified plurality of spikes.

17. The method of claim 16, wherein said determining of the frequency comprises:
calculating, by the computing platform, a Fast Fourier Transform based at least in part on the identified plurality of spikes.

18. A computing platform comprising:
an embedded antenna to receive a radio-frequency signal over a wireless medium, and to transmit the radio-frequency signal over an interconnect, the radio-frequency signal having at least a portion representative of platform interference introduced by the computing platform; and
a receiver having
a signal converter to receive the radio-frequency signal from the interconnect, and to output a baseband signal based at least in part on the radio-frequency signal; and
a platform interference estimator to receive the baseband signal from the signal converter, and to estimate the platform interference based at least in part on the baseband signal.

19. The computing platform of claim 18, wherein the platform interference estimator is to perform said estimating of the platform interference by estimating a narrowband platform interference.

20. The computing platform of claim 18, wherein the platform interference estimator is to generate a platform interference profile having at least one attribute selected from the group consisting of a frequency, an amplitude, and a phase based at least in part on the baseband signal.

21. The computing platform of claim 19, wherein the platform interference profile includes a frequency based at least in part on the baseband signal; the signal converter is to receive the radio-frequency signal over a first time period, to receive another radio-frequency signal over a second time period, and to output another baseband signal based at least in part on the another radio-frequency signal; and the platform interference estimator is to receive the another baseband signal and to augment the platform interference profile with at least one of an amplitude or a phase based at least in part on the another baseband signal.

22. The computing platform of claim 21, wherein the another radio-frequency signal is to have an incoming data transmission, and the computing platform further comprising:
a comparator
to receive the another baseband signal from the signal converter;
to receive the interference signal from the interference signal constructor;
and
to output an adjusted baseband signal based at least in part on the received another baseband signal and the received interference signal.

23. The computing platform of claim 19, further comprising:
an interference signal constructor to receive the platform interference profile from the platform interference estimator, and
to construct an interference signal based at least in part on the platform interference profile.

24. The computing platform of claim 23, further comprising:
a sinusoidal generator to cooperate with the signal interference constructor to construct the interference signal.

25. The computing platform of claim 19, wherein the computing platform is a mobile platform selected from the group consisting of a notebook computing platform, a personal digital assistant, and a cellular phone.
